(19) United States
(12) Patent Application Publication
(10) Pub. No.: US 2026/0196618 A1
(43) Pub. Date: Jul. 9, 2026

(54) SECONDARY BATTERY AND BATTERY MODULE

(71) Applicant: SAMSUNG SDI CO., LTD., Yongin-si (KR)

(72) Inventors: Dae Kyu KIM, Suwon-si (KR); Min Jae KIM, Suwon-si (KR)

(21) Appl. No.: 19/420,985

(22) Filed: Dec. 16, 2025

(30) Foreign Application Priority Data
Jan. 9, 2025 (KR) 10-2025-0003331

(51) Int. Cl. H01M 50/152; H01M 50/107; H01M 50/213; H01M 50/342; H01M 50/548; H01M 50/559

(52) U.S. Cl. CPC H01M 50/152; H01M 50/107; H01M 50/213; H01M 50/3425; H01M 50/548; H01M 50/559

(57) ABSTRACT

A secondary battery includes a case and an electrode assembly accommodated in a case. A terminal portion is coupled to the case, with the terminal portion including a metal layer and a plating layer covering at least a portion of the metal layer. At least a portion of an upper portion of the terminal portion includes a surface treatment forming a pattern.

### CROSS-REFERENCE TO RELATED APPLICATION

The present application claims priority to and the benefit of Korean Patent Application No. 10-2025-0003331, filed on Jan. 9, 2025, in the Korean Intellectual Property Office, the entire disclosure of which is incorporated herein by reference.

### BACKGROUND

### 1. Field of the Disclosure

The present disclosure relates to a secondary battery and a battery module including a plurality of secondary batteries.

### 2. Discussion of Related Art

Unlike primary batteries that cannot be recharged, secondary batteries can be charged and discharged. Low-capacity secondary batteries are used in small portable electronic devices such as smartphones, feature phones, laptop computers, digital cameras, and camcorders. High-capacity secondary batteries are widely used as driving power sources and power storage batteries for motors in hybrid vehicles, electric vehicles, and the like.

A secondary battery includes an electrode assembly including a positive electrode, a negative electrode, and/or a terminal portion electrically connected to the positive electrode or the negative electrode. The terminal portion may be bonded to a connection member, which connects an external device to the secondary battery through welding.

The information disclosed in this section is only for better understanding of the background of the present disclosure. It may contain information that is not prior art.

### SUMMARY OF THE DISCLOSURE

The present disclosure is directed to providing a secondary battery including a surface-treated terminal portion and a battery module including a plurality of secondary batteries. The present disclosure is also directed to providing a secondary battery including a terminal portion having an engraved pattern formed thereon and a battery module including a plurality of secondary batteries. The present disclosure is further directed to providing to a secondary battery including a terminal portion having a roughness formed thereon, and a battery module including a plurality of secondary batteries. The present disclosure is still further directed to providing a battery module including a secondary battery and a connection member bonded to a surface-treated terminal portion of the secondary battery.

However, the technical objectives of the present disclosure are not limited, and other objective that are not described herein will be clearly understood by those skilled in the art based on the following descriptions.

According to an aspect of the present disclosure, there is provided a secondary battery including a case, an electrode assembly accommodated in the case, and a terminal portion coupled to the case, wherein the terminal portion includes a metal layer and a plating layer covering at least a portion of the metal layer, and at least a portion of an upper portion of the terminal portion includes a surface treatment forming a pattern.

According to another aspect of the present disclosure, there is provided a battery module including a plurality of secondary batteries, a housing configured to accommodate the plurality of secondary batteries, and connection member electrically connected to at least a portion of each of the secondary batteries, wherein each of the secondary batteries includes a case, an electrode assembly accommodated in the case, and a terminal portion coupled to the case and electrically connected to the connection member, the terminal portion includes a metal layer and a plating layer covering at least a portion of the metal layer, and at least a portion of an upper portion of the terminal portion includes a surface treatment forming a pattern.

### BRIEF DESCRIPTION OF THE DRAWINGS

The drawings illustrate embodiments of the present disclosure and, together with the following detailed description. However, the present disclosure is not limited to the embodiments shown in the drawings.

FIG. 1 is a cross-sectional view of a cylindrical secondary battery according to an embodiment of the present disclosure;

FIG. 2 is a cross-sectional view of a terminal portion according to an embodiment of the present disclosure;

FIG. 3 is a perspective view of a terminal portion according to one embodiment of the present disclosure;

FIG. 4 is a side view of a terminal portion according to an embodiment of the present disclosure;

FIG. 5 is a cross-sectional view of the terminal portion along line A-A′ of FIG. 3;

FIG. 6 is a cross-sectional view of the terminal portion along line A-A′ of FIG. 3;

FIG. 7 is a schematic view of a metal layer and a plating layer in a terminal portion according to an embodiment of the present disclosure;

FIG. 8 is a schematic view of a terminal portion according to an embodiment of the present disclosure;

FIG. 9 illustrates roughness formed on a terminal portion according to an embodiment of the present disclosure;

FIG. 10 is a schematic view of a terminal portion according to an embodiment of the present disclosure;

FIG. 11 is a schematic view of a pattern formed on a terminal portion according to an embodiment of the present disclosure;

FIG. 12 is a schematic view of a pattern formed on a terminal portion according to an embodiment of the present disclosure;

FIG. 13 is a schematic view of a pattern formed on a terminal portion according to an embodiment of the present disclosure;

FIG. 14 is a perspective view of a battery module according to an embodiment of the present disclosure; and

FIG. 15 is a cross-sectional view of a terminal portion is connected to a connection member according to an embodiment of the present disclosure.

### DETAILED DESCRIPTION OF EXEMPLARY EMBODIMENTS

Hereinafter, embodiments of the present disclosure will be described with reference to the accompanying drawings. It should be understood that the terms used in the present disclosure are not limited to general and dictionary meanings, but should be interpreted based on the meanings and concepts corresponding to technical aspects of the present disclosure on the basis of the principle that the inventor is allowed to define terms appropriately for the best description thereof. Accordingly, embodiments disclosed in the present specification and configurations illustrated in the drawings are merely most exemplary embodiments of the present disclosure and do not represent all of the technical ideas of the present disclosure, and thus it should be understood that there may be various equivalents and modifications that may substitute them at the time of filing of the present application.

Further, “comprise and include” and/or “comprising and including” used in this disclosure should be interpreted as specifying the presence of described shapes, numbers, steps, operations, members, elements, and/or groups thereof and do not exclude the presence or addition of other shapes, numbers, operations, members, elements, and/or groups thereof.

In some embodiments, for a better understanding of the present disclosure, the accompanying drawings are not illustrated on an actual scale and sizes of some elements may be exaggerated. In some embodiments, the same reference numbers may be assigned to the same components in different embodiments.

Stating that two objects of comparison are “the same” means that the two objects of comparison are “substantially the same.” Therefore, substantially the same may include a deviation that is considered low in the art, for example, a deviation of 5% or less. In addition, uniformity of a parameter in a certain area may mean uniformity from an average perspective.

It will be understood that although the terms first, second, and the like are used herein to describe various components, these components should not be limited by these terms. These terms are only used to distinguish one component from another component, and a first component may also be a second component unless particularly described otherwise.

Through the disclosure, each component may be singular or plural unless particularly described otherwise.

Arrangement of any component “on” a component includes not only the arrangement in which any component is disposed to be in contact with the top surface (or bottom surface) of the component, but also the arrangement in which other components may be disposed between the component and any component disposed on (or under) the component.

In addition, when it is said that a certain element is “connected” or “coupled” to another element, this may mean that the elements are directly connected or coupled to each other, but it should be understood that still another element may be “interposed” between the elements or the elements may be “connected” or “coupled” to each other via still another element. Further, the term “electrically coupled” may mean not only “directly coupled” but also may include the meaning “coupled via another interposing component.”

Throughout the specification, “A and/or B” refers to “A, B, or A and B” unless particularly described otherwise. That is, “and/or” includes all or any combination of a plurality of listed items. “C to D” refers to C or more and D or less unless particularly described otherwise.

The terms used in this specification are for describing embodiments of the present disclosure and are not intended to limit the present disclosure.

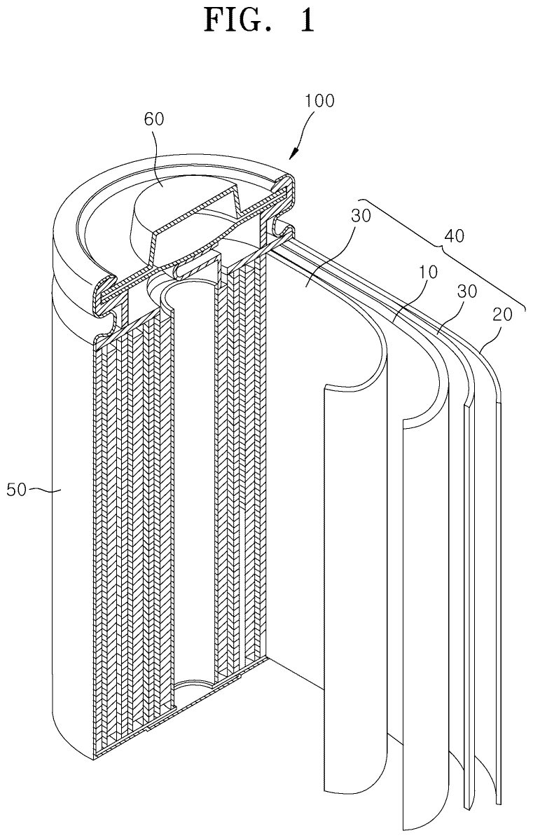

FIG. 1 is a schematic cross-sectional view of a cylindrical secondary battery according to an embodiment of the present disclosure.

As shown in FIG. 1, a secondary battery 100 according to one embodiment of the present disclosure may include a case 50, an electrode assembly 40, and a terminal portion 60. The secondary battery 100 may further include a center pin (not shown). The terminal portion 60 may performs a current interruption operation. Thus, in some cases, the terminal portion 60 is also referred to as a current interruption device.

The case 50 is formed, for example, in a cylindrical shape. The case 50 may include an approximately circular bottom portion and a cylindrical sidewall extending upward from a circumference of the bottom portion by a certain length. A portion of the case 50 may be open. For example, an opening may be formed at an upper portion of the case 50.

During an assembly process of the secondary battery 100, the electrode assembly 40 and/or the center pin may be inserted into the case 50 through the opening together with an electrolyte. The case 50 may be made of, for example, steel, stainless steel, aluminum, an aluminum alloy, or an equivalent thereof. But the present disclosure is not limited to these examples.

The electrode assembly 40 may be accommodated inside the case 50. The electrode assembly 40 may include a negative electrode 20 in which a negative electrode current collector is coated with a negative electrode active material (for example, graphite or carbon), a positive electrode 10 in which a positive electrode current collector is coated with a positive electrode active material (for example, a transition metal oxide (LiCoO₂, LiNiO₂, or LiMn₂O₄)), and a separator 30 positioned between the negative electrode 20 and the positive electrode 10 to prevent a short circuit and allow only the movement of lithium ions. The negative electrode 20, the positive electrode 10, and the separator 30 may be wound around a core to form an approximately cylindrical shape.

The terminal portion 60 forms, for example, a cap assembly. The cap assembly includes an upper cap. The cap assembly may further include at least one of a lower cap, a vent, and an insulator. The terminal portion is coupled to the case 50 to cover the opening and seal the electrode assembly 40 inside the case 50.

The present disclosure is not limited to the embodiment depicted in FIG. 1 For example, the case 50 may be formed various shapes such as a circular shape and a pouch shape. The case 50 may be made of a metal such as aluminum, an aluminum alloy, nickel-plated steel, or a laminate film or plastic constituting a pouch. The terminal portion 60 may be formed to correspond to the shape of the case 50, the shape/position of the opening formed in the case 50, and/or the shape of the electrode assembly 40. In addition, the terminal portion 60 may be referred to by various names according to a shape thereof. For example, the terminal portion 60 may be referred to by various names such as a terminal, a rivet, a cap plate, a cap assembly, and the like.

As described above, the electrode assembly 40 includes the negative electrode 20, the positive electrode 10, and the separator 30 positioned between the negative electrode 20 and the positive electrode 10. The electrode assembly 40 is accommodated in the cylindrical case 50 together with an electrolyte (not shown). Hereinafter, the electrode assembly 40 and the electrolyte will be described.

### Positive Electrode Active Material

As a positive electrode active material for the positive electrode of the electrode assembly, a lithiated intercalation compound capable of reversibly intercalating and deintercalating lithium may be used. Specifically, at least one composite oxide of lithium and a metal selected from cobalt, manganese, nickel, and a combination thereof may be used.

The composite oxide may be a lithium transition metal composite oxide, and specific examples of the composite oxide include lithium nickel-based oxide, lithium cobalt-based oxide, lithium manganese-based oxide, a lithium iron phosphate-based compound, cobalt-free nickel-manganese-based oxide, or a combination thereof. As examples, a compound represented by any one of formulas below may be used: LiₐA_{1-b}X_{b}O_{2-c}D_{c}, wherein 0.90≤a≤1.8, 0≤b≤0.5, and 0≤c≤0.05; LiₐMn_{2-b}X₆O_{4-c}D_{c}, wherein 0.90≤a≤1.8, 0≤b≤0.5, and 0≤c≤0.05; LiₐNi_{1-b-c}Co_{b}X_{c}O_{2-α}D_{α}, wherein 0.90≤a≤1.8, 0≤b≤0.5, 0≤c≤0.5, and 0<α<2; LiₐNi_{1-b-c}Mn_{b}X_{c}O_{2-α}D_{α}, wherein 0.90≤a≤1.8, 0≤b≤0.5, 0≤c≤0.5, and 0<α<2; LiₐNi_{b}Co_{c}L¹_{d}GₑO₂, wherein 0.90≤a≤1.8, 0≤b≤0.9, 0≤c≤0.5, 0≤d≤0.5, and 0≤e≤0.1; LiₐNiG_{b}O₂, wherein 0.90≤a≤1.8 and 0.001≤b≤0.1; LiₐCoG_{b}O₂, wherein 0.90≤a≤1.8 and 0.001≤b≤0.1; LiₐMn_{1-b}G_{b}O₂, wherein 0.90≤a≤1.8 and 0.001≤b≤0.1; LiₐMn₂G_{b}O₄, wherein 0.90≤a≤1.8 and 0.001≤b≤0.1; LiₐMn_{1-g}G_{g}PO₄, wherein 0.90≤a≤1.8 and 0≤g≤0.5; Li_{(3-f)}Fe₂(PO₄)₃, wherein 0≤f≤2; and LiₐFePO₄, wherein 0.90≤a≤1.8. In these formulas, A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

In an example, the positive electrode active material may be a high-nickel-based positive electrode active material in which in the lithium transition metal composite oxide, an amount of nickel is 80 mol % or more, 85 mol % or more, 90 mol % or more, 91 mol % or more, or in a range of about 94 mol % to about 99 mol % with respect to 100 mol % of metal in the material excluding lithium. The high-nickel-based positive electrode active material may provide high capacity and thus may be used in high-capacity and high-density secondary batteries.

### Positive Electrode

The positive electrode 10 for the secondary battery 100 may include a current collector and a positive electrode active material layer formed on the current collector. The positive electrode active material layer may include a positive electrode active material and may further include a binder and/or a conductive material. The positive electrode 10 may further include an additive that may serve as a sacrificial positive electrode.

An amount of the positive electrode active material may be in a range of 90 wt % to 99.5 wt % with respect to 100 wt % of the positive electrode active material layer, and an amount of each of the binder and the conductive material may be in a range of 0.5 wt % to 5 wt % with respect to 100 wt % of the positive electrode active material layer.

The binder may serve to attach positive electrode active material particles properly to each other and also attach the positive electrode active material properly to the current collector. Representative examples of the binder include polyvinyl alcohol, carboxymethyl cellulose, hydroxypropyl cellulose, diacetyl cellulose, polyvinyl chloride, carboxylated polyvinyl chloride, polyvinyl fluoride, a polymer including ethylene oxide, polyvinylpyrrolidone, polyurethane, polytetrafluoroethylene, polyvinylidene fluoride, polyethylene (PE), polypropylene (PP), styrene-butadiene rubber, (meth)acrylated styrene-butadiene rubber, an epoxy resin, a (meth)acrylic resin, a polyester resin, nylon, and the like. But the present disclosure is not limited to these examples.

The conductive material may be used to impart conductivity to an electrode, and any electron-conductive material may be used as long as the electron-conductive material may not cause an undesirable chemical change in the battery to be made. Examples of the conductive material include a carbon-based material such as natural graphite, artificial graphite, carbon black, acetylene black, Ketjen black, carbon fiber, carbon nanofibers, or carbon nanotubes; a metal-based material containing copper, nickel, aluminum, silver, or the like and having a form of a metal powder or metal fiber; a conductive polymer such as a polyphenylene derivative; or a mixture thereof.

Aluminum (Al) may be used as the current collector. But the present disclosure is not limited thereto.

### Negative Electrode Active Material

A negative electrode active material for the negative electrode of the electrode assembly includes a material capable of reversibly intercalating/deintercalating lithium ions, a lithium metal, a lithium metal alloy, a material capable of doping and undoping lithium, or a transition metal oxide.

The material capable of reversibly intercalating/deintercalating lithium ions may include a carbon-based negative electrode active material, for example, crystalline carbon, amorphous carbon, or a combination thereof. Examples of the crystalline carbon may include graphite such as natural graphite or artificial graphite in an amorphous, plate-like, flake-like, spherical, or fibrous form. Examples of the amorphous carbon may include soft carbon, hard carbon, mesophase pitch carbide, or fired coke.

The lithium metal alloy may include an alloy of lithium and a metal selected from Na, K, Rb, Cs, Fr, Be, Mg, Ca, Sr, Si, Sb, Pb, In, Zn, Ba, Ra, Ge, Al, and Sn.

As the material capable of doping and undoping lithium, a Si-based negative electrode active material or a Sn-based negative electrode active material may be used. The Si-based negative electrode active material may be silicon, a silicon-carbon composite, SiOₓ (0<x<2), a Si-Q alloy, or a combination thereof. In the formula Si-Q, Q is selected from an alkali metal, an alkaline earth metal, a Group 13 element, a Group 14 element (excluding Si), a Group 15 element, a Group 16 element, a transition metal, a rare earth element, and a combination thereof. The Sn-based negative electrode active material may be Sn, SnO₂, a Sn-based alloy, or a combination thereof.

The silicon-carbon composite may be a composite of silicon and amorphous carbon. According to an embodiment, the silicon-carbon composite may be in the form of silicon particles, with amorphous carbon coated on the surfaces of the silicon particles. For example, the silicon-carbon composite may include secondary particles (core) formed by bonding primary silicon particles and an amorphous carbon plating layer (shell) located on surfaces of the secondary particles. The amorphous carbon may also be located between the silicon primary particles, and thus, for example, the silicon primary particles may be coated with amorphous carbon. The secondary particles may be dispersed in an amorphous carbon matrix.

The silicon-carbon composite may further include crystalline carbon. The silicon-carbon composite may include, for example, a core including crystalline carbon and silicon particles and an amorphous carbon plating layer located on a surface of the core.

The Si-based negative electrode active material or Sn-based negative electrode active material may be used after being mixed with a carbon-based negative electrode active material.

### Negative Electrode

The negative electrode 20 for the secondary battery 100 includes a current collector and a negative electrode active material layer provided on the current collector. The negative electrode active material layer may include a negative electrode active material and may further include a binder and/or a conductive material. For example, the negative electrode active material layer may include the negative electrode active material in an amount of 90 wt % to 99 wt %, the binder in an amount of 0.5 wt % to 5 wt %, and the conductive material in an amount of 0 wt % to 5 wt %.

The binder may serve to attach negative electrode active material particles properly to each other and also attach the negative electrode active material properly to the current collector. The binder may be a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene (PE), polypropylene (PP), polyamideimide, polyimide, or a combination thereof.

The aqueous binder may be selected from styrene-butadiene rubber, (meth)acrylated styrene-butadiene rubber, (meth)acrylonitrile-butadiene rubber, (meth)acrylic rubber, butyl rubber, fluorine rubber, polyethylene oxide, polyvinylpyrrolidone, polyepichlorohydrin, polyphosphazene, poly(meth)acrylonitrile, an ethylene propylene diene copolymer, polyvinyl pyridine, chlorosulfonated polyethylene, latex, a polyester resin, a (meth)acrylic resin, a phenol resin, an epoxy resin, polyvinyl alcohol, and a combination thereof.

When the aqueous binder is used as the negative electrode binder, the aqueous binder may further include a cellulose-based compound capable of imparting viscosity. As the cellulose-based compound, one or more types of carboxymethyl cellulose, hydroxypropylmethyl cellulose, methyl cellulose, and an alkali metal salt thereof may be mixed and used. As the alkali metal, Na, K, or Li may be used.

The dry binder may include a polymer material capable of being fiberized, such as polytetrafluoroethylene, polyvinylidene fluoride, a polyvinylidene fluoride-hexafluoropropylene copolymer, polyethylene oxide, or a combination thereof.

The conductive material may be used to impart conductivity to an electrode, and any electron-conductive material may be used as long as the electron-conductive material that does not cause an undesirable chemical change in the battery to be made. Specific examples of the conductive material include a carbon-based material such as natural graphite, artificial graphite, carbon black, acetylene black, Ketjen black, carbon fiber, carbon nanofibers, or carbon nanotubes; a metal-based material containing copper, nickel, aluminum, silver, or the like and having a form of a metal powder or metal fiber; a conductive polymer such as a polyphenylene derivative; or a mixture thereof.

The negative electrode current collector may be formed from copper foil, nickel foil, stainless steel foil, titanium foil, nickel foam, copper foam, a polymer substrate coated with a conductive metal, or a combination thereof.

### Electrolyte

An electrolyte for the secondary battery 100 may include a non-aqueous organic solvent and a lithium salt.

The non-aqueous organic solvent serves as a medium through which ions involved in an electrochemical reaction of a battery may move.

The non-aqueous organic solvent may be a carbonate-based solvent, an ester-based solvent, an ether-based solvent, a ketone-based solvent, an alcohol-based solvent, an aprotic solvent, or a combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate. (EC), propylene carbonate (PC), butylene carbonate (BC), or the like.

The ester-based solvent may include methyl acetate, ethyl acetate, n-propyl acetate, dimethyl acetate, methyl propionate, ethyl propionate, decanolide, mevalonolactone, valerolactone, caprolactone, or the like.

The ether-based solvent may include dibutyl ether, tetraglyme, diglyme, dimethoxyethane, 2-methyltetrahydrofuran, 2,5-dimethyltetrahydrofuran, tetrahydrofuran, or the like. In addition, the ketone-based solvent may include cyclohexanone or the like. The alcohol-based solvent may include ethyl alcohol, isopropyl alcohol, or the like. The aprotic solvent may include nitriles such as R—CN (R is a C₂-C₂₀ linear, branched, or ring structure hydrocarbon group and includes a double bond, an aromatic ring, or an ether group); amides such as dimethylformamide; dioxolanes such as 1,3-dioxolane and 1,4-dioxolane; or sulfolanes.

The non-aqueous organic solvent may be used alone or in combination of two or more types thereof.

When the carbonate-based solvent is used, cyclic carbonate and chain carbonate may be mixed and used, and the cyclic carbonate and the chain carbonate may be mixed at a volume ratio of 1:1 to 1:9.

The lithium salt may be a material that dissolves in an organic solvent, serves as a source of lithium ions in a battery, enables the basic operation of a secondary battery, and serves to promote the movement of lithium ions between a positive electrode and a negative electrode. Representative examples of the lithium salt include LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, lithium bis(fluorosulfonyl)imide (Li(FSO₂)₂N) (LiFSI), LiC₄F₉SO₃, LiN(CₓF₂ₓ₊₁SO₂)(C_{y}F_{2y+1}SO₂), wherein x and y are each an integer from 1 to 20, lithium trifluoromethane sulfonate, lithium etrafluoroethanesulfonate, lithium difluorobis(oxalato)phosphate (LiDFOB), and lithium bis(oxalato) borate (LiBOB).

### Separator

Depending on the type of the secondary battery 100, the separator 30 may be present between the positive electrode 10 and the negative electrode 20. The separator 30 may be PE, PP, polyvinylidene fluoride, or a multilayer thereof having two or more layers. Also, a mixed multilayer such as a PE/PP double-layered separator, a PE/PP/PE triple-layered separator, or a PP/PE/PP triple-layered separator may be used.

The separator 30 may include a porous substrate and a plating layer that includes an organic material, an inorganic material, or a combination thereof and is provided on one surface or both surfaces of the porous substrate.

The porous substrate may be a polymer film formed of any one polymer selected from a polyolefin such as PE, or PP, a polyester such as polyethylene terephthalate (PET) or polybutylene terephthalate, polyacetal, polyamide, polyimide, polycarbonate, polyether ketone, polyaryl ether ketone, polyetherimide, polyamideimide, polybenzimidazole, polyethersulfone, polyphenylene oxide, a cyclic olefin copolymer, polyphenylene sulfide, polyethylene naphthalate, glass fiber, TEFLON®, and polytetrafluoroethylene, or a copolymer or mixture of two or more types thereof.

The organic material may include a polyvinylidene fluoride-based polymer or a (meth)acrylic-based polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof. But the present disclosure is not limited to these examples.

The organic material and the inorganic material may be mixed and provided in one coating layer or may be provided in a form in which a coating layer including an organic material and a coating layer including an inorganic material are stacked.

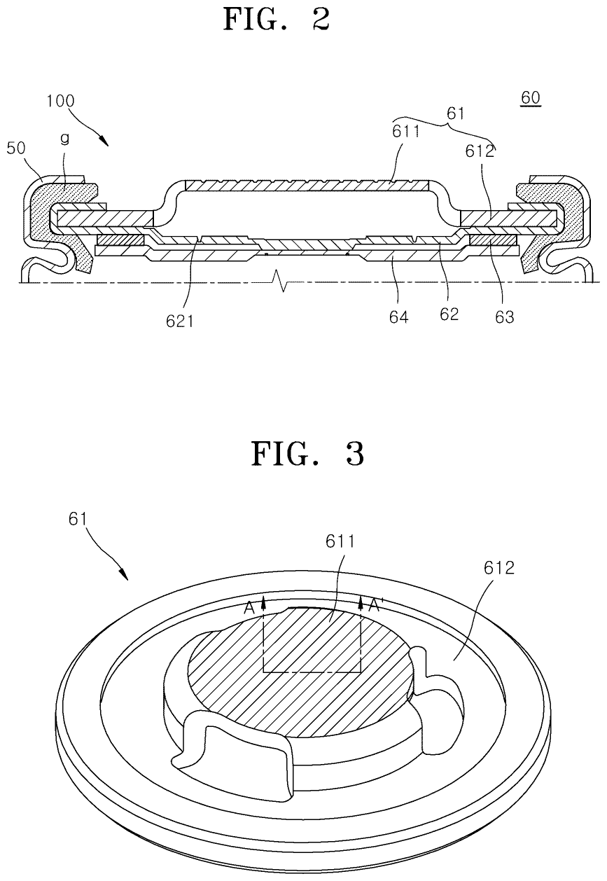

FIG. 2 is a cross-sectional view of a terminal portion according to an embodiment of the present disclosure.

The terminal portion 60 includes a metal layer M (see FIG. 5), and a plating layer P (see FIG. 7) covering at least a portion of the metal layer M. At least a part of an upper portion of the terminal portion 60 includes a pattern 61P that is surface-treated.

The secondary battery 100 includes, for example, the cylindrical secondary battery as described above with reference to FIG. 1. However, the secondary battery 100 is not limited thereto. For example, the secondary battery 100 may include any type thereof such as a foldable prismatic battery, a direct-connected prismatic battery, or a large-diameter battery that includes a terminal portion that is electrically connected to an external device. Hereinafter, an example in which the secondary battery 100 is a cylindrical secondary battery will be described.

The terminal portion 60 is electrically connected to the electrode assembly 40. The terminal portion may be directly connected to the electrode assembly 40 in one example, In another example, the terminal portion 60 may be connected to the electrode assembly 40 by another component.

The terminal portion 60 includes a negative terminal portion and/or a positive terminal portion. The positive terminal portion is electrically connected to a positive electrode 10. The negative terminal portion is electrically connected to a negative electrode 20.

The terminal portion 60 is exposed to outside of the case 50. The terminal portion 60 may be coupled to the case 50 and protrude to the outside of the case 50. In other embodiments, the terminal portion 60 may be formed integrally with the case 50. And in other embodiments, the case 50 may serve as a terminal portion.

The terminal portion 60 may include a cap assembly as described herein. In some embodiments, when the secondary battery 100 is a large-diameter battery, the terminal portion may include a rivet terminal. But the terminal portion may include any component that electrically connects the electrode assembly to an external device. Hereinafter, an example of a case in which the terminal portion 60 includes a cap assembly will be described.

The terminal portion 60 is connected to the case 50 adjacent to the opening. For example, when the opening of the case 50 is formed at an upper portion of the case 50, the terminal portion 60 is coupled to the upper portion of the case 50. In another example, when the opening of the case 50 is formed at a lower portion of the case 50, the terminal portion 60 is coupled to the lower portion of the case 50.

Hereinafter, each of the components of the terminal portion 60 will be described in an example in which the terminal portion 60 is coupled to the upper portion of the case 50.

The terminal portion 60 seals the inside of the case 50. As described with reference to FIG. 1, the secondary battery 100 includes the electrode assembly 40 and the electrolyte (not shown) accommodated inside the case 50. The terminal portion 60 allows the electrode assembly 40 and the electrolyte to be safely accommodated inside the case 50.

The terminal portion 60 prevents heat from spreading to an adjacent secondary battery 100 and/or prevents the secondary battery 100 from exploding. The terminal portion 60 is electrically connected to electrodes extending from the electrode assembly 40 (for example, the positive electrode 10 and/or the negative electrode 20 described with reference to FIG. 1). The electrodes are electrically connected to an external device. Thus, the terminal portion 60 allows the secondary battery 100 to receive or supply a current from or to the external device.

The terminal portion 60 includes an upper cap 61. The terminal portion 60 may further include a lower cap 64, a vent 62, and an insulator 63. In the depicted example, the u lower cap 64 is located below the upper cap 61, and the vent 62, including a notch 621, is located between the upper cap 61 and the lower cap 64. The insulator 63 is located between the lower cap 64 and the vent 62 and insulates between the lower cap 64 and the vent 62. The terminal portion 60 may further include a sub-plate connecting the terminal portion 60 and the electrode assembly 40.

The upper cap 61 may be located at an uppermost side of the terminal portion 60. The upper cap 61 is may be in contact with an external circuit (for example, a connection member 300 as shown in FIG. 15).

The upper cap 61 includes an edge portion 612, and a ridge portion 611 that convexly protrudes upward from the edge portion 612 to form an upper portion of the upper cap 61. The ridge portion 611 provides an area that is connectable to the connection member 300. The edge portion 612 provides an area through which the upper cap 61 may be coupled to the lower cap 64, a gasket g, and/or the case 50. The upper cap 61 may further include one or more outlets for discharging gas around the ridge portion 611.

The lower cap 64 is located below the upper cap 61. One or more holes may be formed in at least a portion of the lower cap 64.

The vent 62 is located between the upper cap 61 and the lower cap 64. The vent 62 may be convex downward and include at least one notch 621. The notch 621 may be located, for example, in at least a portion of an area formed to be convex downward in the vent 62. The vent 62 may release gas formed inside the secondary battery 100 to outside of the case 50 through the notch 621.

When the secondary battery 100 is overcharged and/or the secondary battery 100 operates abnormally, gas may be generated inside the secondary battery 100. And the pressure inside the case 50 increases due to the gas. When the internal pressure of the secondary battery 100 increases, the vent 62 may be deformed so that the area that is convex downward deforms upward due to the pressure. Accordingly, the vent 62 may be electrically disconnected from the electrode assembly 40. In addition, the vent 62 may be broken along the notch 621 to release gas to outside of the case 50. Thus, the terminal portion 60 may prevent the secondary battery 100 from exploding.

The insulator 63 is located between the lower cap 64 and the vent 62. For example, the insulator 63 is located at an edge between the lower cap 64 and the vent 62. The insulator 63 may be formed to have a ring shape surrounding the edge between the lower cap 64 and the vent 62. Thus, the insulator 63 forms a gap between the lower cap 64 and the vent 62.

The insulator 63 electrically insulates the lower cap 64 from the vent 62. In some examples, the insulator 63 may include a resin material such as PE, PP, or PET.

The insulator 63 may melt when a temperature inside the case 50 rises. Gas generated inside the case 50 flows into the gap between the lower cap 64 and the vent 62. The flowing gas increases the pressure of a space between the lower cap 64 and the vent 62 to cause the vent 62 to be ruptured due to the pressure. The gas may be released to outside through the ruptured vent 62. Accordingly, the gas generated inside the case 50 is released to outside of the case 50.

The sub-plate (not shown) is located below the lower cap 64. The sub-plate may be fixed to a lower surface of the lower cap 64 to close the hole formed in the lower cap 64. In addition, the sub-plate may fix the area formed to be convex downward in the vent 62 or may be electrically connected to the area.

In addition, the sub-plate is located above the electrode assembly 40 and may be connected to a tab extending from the electrode assembly 40. For example, the sub-plate may have a first surface in contact with the vent 62 and/or lower cap 64 and a second surface in contact with the tab. The sub-plate may also be bonded to a tab 41 through welding, and the tab may be electrically connected to each of the positive electrode 10 and/or the negative electrode 20 described with reference to FIG. 1. As such, the tab is formed to extend from each of the positive electrode 10 and/or the negative electrode 20. In an example, the tab includes a positive electrode tab that is bonded to a positive electrode plate of the positive electrode 10 and extends from the positive electrode plate to an upper side of the electrode assembly 40 to be connected to the sub-plate.

FIG. 3 is a schematic perspective view illustrating a terminal portion according to an embodiment of the present disclosure.

As describe above, a secondary battery 100 according to one embodiment of the present disclosure includes a case 50 for accommodating an electrode assembly 40 and a terminal portion 60 coupled to the case 50. In some embodiments of the present disclosure, at least a portion of an upper portion of the terminal portion 60 includes a pattern 61P (see FIG. 5) that is surface treated. As also described above, the terminal portion 60 may include a cap assembly that includes a upper cap 61. In FIG. 3, only the upper cap 61 is shown.

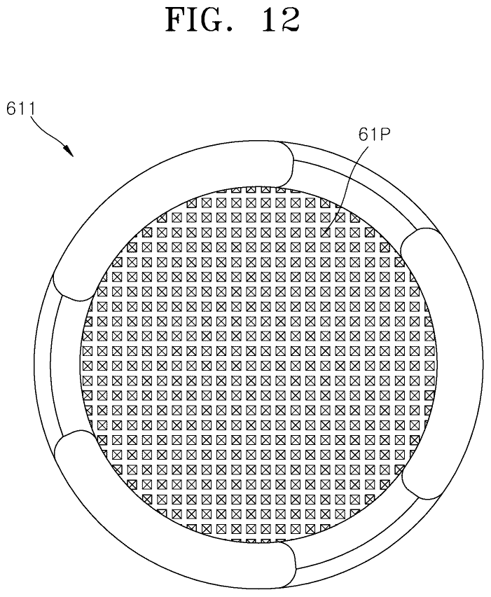

As shown in FIG. 3, the upper cap 61 includes a ridge portion 611 and an edge portion 612. As described above, the ridge portion 611 provides an area that is connectable to a connection member 300 (see FIG. 12). For example, the ridge portion 611 may be bonded and connected to the connection member 300. More specifically, the ridge portion 611 may be welded and connected to the connection member 300 through various welding methods including laser welding, ultrasonic welding, pulse width modulation (PWM) welding, and the like.

At least a portion of the terminal portion 60 may include a pattern that is surface treated. For example, the terminal portion 60 may include a pattern formed on the ridge portion 611 that is connected to the connection member 300. The pattern includes any shape formed through surface treatment, such as an engraved pattern or roughness. Thus, the terminal portion 60 may improve the bonding of the terminal portion 60 to the connection member 300.

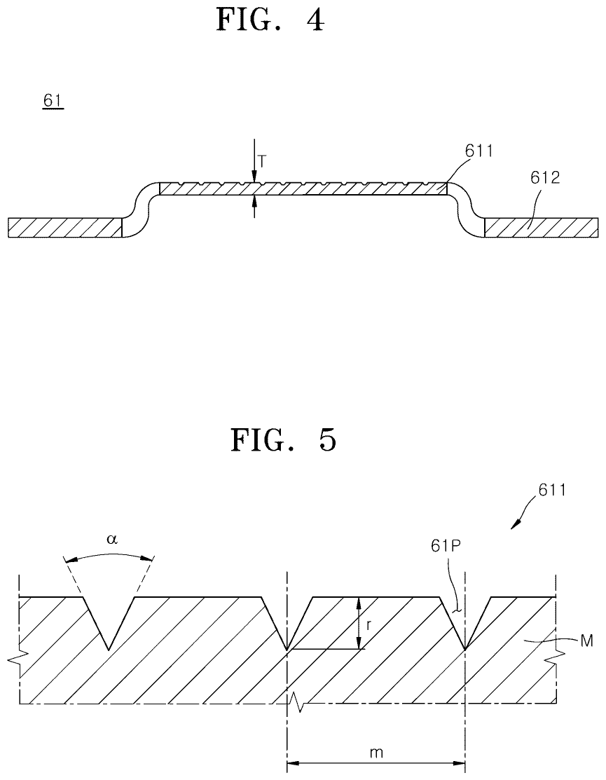

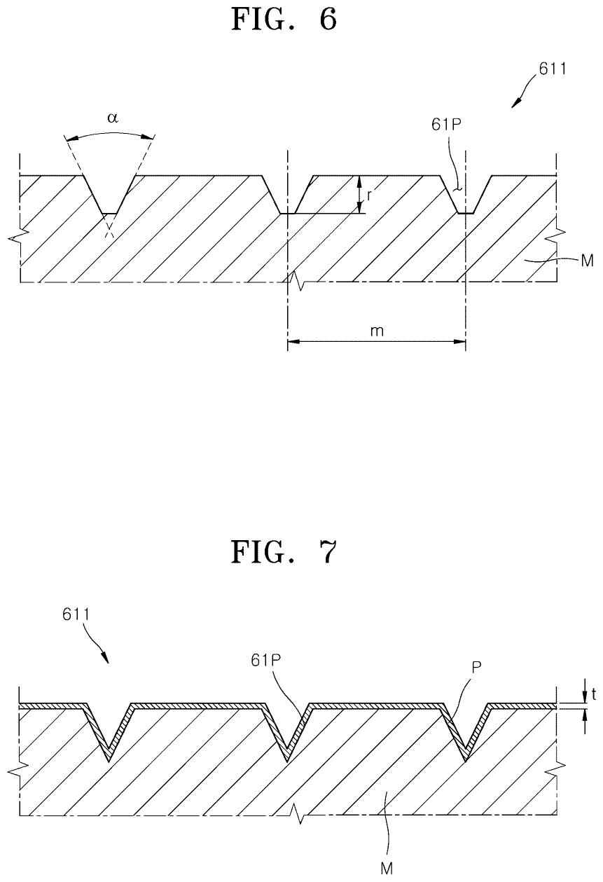

Hereinafter, various shapes of the pattern will be described. FIG. 4 is a side view illustrating a terminal portion according to an embodiment of the present disclosure. FIG. 5 is a cross-sectional view of the terminal portion along line A-A′ of FIG. 3. FIG. 6 is a cross-sectional view of the terminal portion along line A-A′ of FIG. 3.

A secondary battery 100 according to an embodiment of the present disclosure includes an electrode assembly 40, a case 50 for accommodating the electrode assembly 40, and a terminal portion 60 coupled to an opening of the case 50. At least a portion of an upper portion of the terminal portion 60 includes a pattern 61P that is formed by surface treatment, e.g., engraving.

As described with reference to FIGS. 1 to 3, the terminal portion 60 may include a cap assembly, for example, an upper cap 61. In FIGS. 4 to 6, only the upper cap 61 is shown. However, the description of the terminal portion 60 is limited in this regard, and descriptions to be provided below may be modified to have the same or similar with terminal portions 60 of other various shapes.

FIG. 4 is a view of the upper cap 61 viewed from the front or side. As shown in FIG. 4, the upper cap 61 includes a ridge portion 611 and an edge portion 612. In this case, the ridge portion 611 refers to an area that is connected to a connection member 300. In other embodiments where the entire area of the terminal portion 60 is connected to the connection member 300, the description of the ridge portion 611 below may be applied to the entire area or partial area of the terminal portion 60.

The terminal portion 60 includes a metal layer M. For example, the upper cap 61 includes the metal layer M. Thus, the terminal portion may electrically connect components included in the secondary battery 100 and/or components outside the secondary battery 100 (for example, including the electrode assembly 40 and the connection member 300). The metal layer M may be formed from any material having conductivity. For example, the metal layer M includes a metal. For example, the metal layer M may include aluminum (Al), iron (Fe), SPCE, SUS, copper (Cu), nickel (Ni), tungsten (W), gold (Au), silver (Ag), platinum (Pt), or an alloy thereof. However, a material included in the metal layer M is not limited to these examples. In an example, the metal layer M may include a semiconductor. Further, the metal layer M may include a material in which an insulating material is coated with a conductive polymer.

The metal layer M includes the pattern 61P formed on at least a portion thereof. For example, the metal layer M includes the pattern 61P formed in at least an upper portion of the metal layer M. The area in which the pattern 61P is formed may be an area to which an external circuit (including, for example, a connection member 300) is welded.

In some examples, the pattern 61P includes an engraved pattern formed as grooves in the metal layer M. The engraved pattern may be formed, for example, by a laser or by a die.

FIG. 5 is an enlarged cross-sectional view of a surface of the ridge portion 611. In this example, the pattern 61P includes a plurality of engraved patterns having widths that narrow from an upper portion to a lower portion.

The pattern 61P may have a shape with an apex at a lower portion. For example, the pattern 61P may be formed in an inverted cone shape, an inverted polygonal pyramid shape (including, for example, a triangular pyramid shape, a quadrangular pyramid shape, a pentagonal pyramid shape, or a hexagonal pyramid shape), an inverted elliptical pyramid shape, or the like. In other examples, the pattern 61P may be an inverted polygonal columnar shape and disposed to have a furrow-like shape. As such, the shape of the pattern 61P may be f be easily formed in the terminal portion 60. The pattern 61P can improve the tensile strength of the terminal portion 60 after welding.

FIG. 6 is an enlarged cross-sectional view of a surface of the ridge portion 611. In this example, the pattern 61P includes a plurality of engraved patterns having widths that narrow from upper portions to lower portions, with the lower portions forming flat surfaces. Thus, the pattern 61P may have a shape in which the lower portion forms flat surfaces. In such a pattern 61P, the shapes in which the lower portion and the upper portion are parallel to each other.

By forming the pattern 61P in such shapes, the pattern 61P may be easily coated with a plating layer P described below with reference to FIG. 7. Further, the pattern 61P can improve the tensile strength of the terminal portion 60 after welding.

In FIGS. 5 and 6, r denotes a depth of the engraved pattern 61P. The depth r of the pattern 61P is the shortest distance from an uppermost portion of the pattern 61P to a lowermost portion of the pattern 61P.

In some embodiments, the pattern 61P includes an engraved pattern formed to have a depth r of 20.0% or less of a thickness T of the upper cap 61. Alternatively, for example, the pattern 61P includes an engraved pattern formed to have a depth r of 10.0% or less of the thickness T of the upper cap 61. Alternatively, for example, the pattern 61P includes an engraved pattern formed to have a depth r of 12.5% or less of the thickness T of the upper cap 61. Alternatively, for example, the pattern 61P includes an engraved pattern formed to have a depth r of 10.0% or less of the thickness T of the upper cap 61.

In this case, the thickness T of the upper cap 61 is a thickness of an area on which the pattern 61P is formed. For example, the thickness T of the upper cap 61 is an average thickness of the ridge portion 611.

In some embodiments, the depth r of the pattern 61P may be formed to be 30.0% or less of the thickness T of the metal layer M. In other embodiments, the depth r of the pattern 61P may be formed to be 25.0% or less of the thickness T of the metal layer M, the depth r of the pattern 61P may be formed to be 20.0% or less of the thickness T of the metal layer M, the depth r of the pattern 61P may be formed to be 15.0% or less of the thickness T of the metal layer M, the depth r of the pattern 61P may be formed to be 12.5% or less of the thickness T of the metal layer M, or the depth r of the pattern 61P may be formed to be 10.0% or less of the thickness T of the metal layer M.

The pattern 61P may include an engraved pattern formed to a depth r of 1.0% or more of the thickness T of the upper cap 61. In other embodiment, the pattern 61P may include an engraved pattern formed to have a depth r of 2.0% or more of the thickness T of the upper cap 61, or the pattern 61P may include an engraved pattern formed to have a depth r of at least 3.0% of the thickness T of the upper cap 61. In a specific example, when the thickness T of the upper cap 61 is 0.6 mm, the depth r of the pattern 61P may be 0.06 mm or less.

When the depth r of the pattern 61P exceeds 20.0% of the thickness T of the upper cap 61, it may be difficult to form the plating layer P (described below). For example, when the depth r of the pattern 61P exceeds 20.0% of the thickness T of the upper cap 61, the engraved pattern may not be uniformly plated with the plating layer P. In this case, the agglomerating of the plating layer P may occur within the engraved pattern, and/or an area may not be coated with the plating layer P in at least a portion of the engraved pattern.

When the depth r of the pattern 61P is less than 1.0% of the thickness T of the upper cap 61, the terminal portion 60 may not obtain advantageous effects described herein resulting from the pattern 61P, such as a tensile strength improvement. As another example, when the depth r of the pattern 61P is less than 1.0% of the thickness T of the upper cap 61, the weldability of the terminal portion 60 with the connection member 300 may not be improved.

Thus, it is preferable that the pattern 61P be formed to a depth of 1.0% to 20.0% of the thickness T of the upper cap 61.

In FIGS. 5 and 6, m denotes an interval of the pattern 61P. That is, the interval M of the pattern 61P is a distance between an engraved pattern and an adjacent engraved pattern. In this case, the interval M of the pattern 61P may be the interval between a center of the engraved pattern and a center of the adjacent engraved pattern. In an example, the interval M of the pattern 61P may be 15 times or less the depth r of the pattern 61P. In another example, the interval M of the pattern 61P may be 14 times or less the depth r of the pattern 61P, the interval M of the pattern 61P may be 13 times or less of the depth r of the pattern 61P, the interval M of the pattern 61P may be 12 times or less the depth r of the pattern 61P, or the interval M of the pattern 61P may be 11 times or less the depth r of the pattern 61P. Further, the interval M of the pattern 61P may be three times or more the depth r of the pattern 61P In a specific example, when the thickness T of the upper cap 61 is 0.6 mm, the depth r of the pattern 61P may be 0.06 mm or less, and the interval M of the pattern 61P may be 0.65 mm.

When the interval M of the pattern 61P exceeds 15 times the depth r of the pattern 61P, the density of the pattern 61P may be decreased such that a contact area between the terminal portion 60 and the connection member 300 may not be sufficiently secured. That is, tensile strength after welding between the terminal portion 60 and the connection member 300 may not be improved. When the interval M of the pattern 61P is less than three times the depth r of the pattern 61P, the pattern 61P may have an excessively high density, and tensile strength after welding between the terminal portion 60 and the connection member 300 may not be improved. Thus, it is preferable that the interval M of the pattern 61P be formed to be in a range of 3 times to 15 times the depth r of the pattern 61P.

In FIGS. 5 and 6, a denotes an angle of the pattern 61P. For example, the angle α of the pattern 61P indicates a degree by which the engraved pattern narrows from an upper portion to a lower portion. As shown in FIG. 6, when a lower portion of the pattern 61P is formed as a flat surface as shown in FIG. 6, the angle α of the pattern 61P may be formed by lines that extend along the surfaces of the pattern 61P.

In some embodiments, the angle α of the pattern 61P may be 60° to 120°. In other embodiments, the angle α of the pattern 61P may be 70° to 120, the angle α of the pattern 61P may be 80° to 120, the angle α of the pattern 61P may be 60° to 110°, the angle α of the pattern 61P may be 70° to 110°, the angle α of the pattern 61P may be 80° to 110, the angle α of the pattern 61P may be 60° to 100°, the angle α of the pattern 61P may be 70° to 100°, the angle α of the pattern 61P may be 80° to 100°, or the angle α of the pattern 61P may be 90°.

When the angle α of the pattern 61P is less than 60°, a width of the pattern 61P may be too narrow, such that it is difficult to coat the pattern 61P with the plating layer P. When the angle α of the pattern 61P exceeds 120°, the pattern 61P may not form a sufficient unevenness on the terminal portion 60. And in such a case, it may not be possible to secure a sufficient contact area for connection between the terminal portion 60 and the connection member 300. Thus, it is preferable that the angle α of the pattern 61P be formed to be in a range of 60° to 120°.

As such, in embodiments of the present disclosure the terminal portion 60 may include the pattern 61P, such as a plurality of engraved patterns. With such a structure, the terminal portion 60 may increase a contact area with the connection member 300 to improve the welding strength with the connection member 300. In addition, the terminal portion 60 is connected to the connection member 300 through a large area, thereby allowing a current path to be longer.

FIG. 7 is a schematic view of a metal layer and a plating layer in a terminal portion according to an embodiment of the present disclosure.

A secondary battery 100 according to one embodiment of the present disclosure (includes a case 50 for accommodating an electrode assembly 40, and a terminal portion 60 coupled to an opening of the case 50. The terminal portion 60 includes a metal layer M, and a plating layer P that surrounds at least a portion of the metal layer M, and at least a portion of an upper portion of the terminal portion 60 includes a pattern 61P that is surface-treated.

As described above with reference to FIGS. 4 to 6, the metal layer M includes conductive materials. For example, the metal layer M may include a metal.

The plating layer P is formed on at least a portion of the metal layer M. For example, the plating layer P may be applied to the metal layer M and cover an entire surface of the metal layer M. In other embodiments, the plating layer P may cover only a portion of the surface of the metal layer M.

The plating layer P may prevent oxidation of the metal layer M. Additionally or alternatively, the plating layer P may protect the metal layer M and/or improve the strength of the metal layer M.

In some examples, the plating layer P includes a metal such as nickel (Ni), copper (Cu), tungsten (W), or alloys thereof. However, the material included in the plating layer P is not limited to these examples, and the plating layer P may include any material capable of physically and/or chemically protecting the metal layer M.

As described above with reference to FGS. 4 to 6, the terminal portion 60 includes the pattern 61P. As shown in FIG. 7, the pattern 61P is formed on at least a portion of the upper portion of the metal layer M.

In this way, the plating layer P may be formed to entirely or partially cover an area of the metal layer M on which the pattern 61P is formed and an area of the metal layer M on which the pattern 61P is not formed. Accordingly, the plating layer P may form an unevenness having a shape corresponding to the pattern 61P formed on the metal layer M.

In such embodiments, the terminal portion 60 includes the pattern 61P, which is surface-treated, on at least a portion thereof. Thus, the terminal portion 60 can improve the welding strength between the secondary battery 100 and a connection member 300 and/or may improve tensile strength after performing welding with the connection member 300.

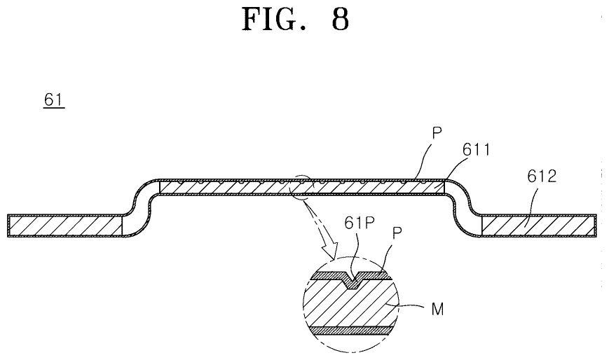

FIG. 8 is a schematic view of a terminal portion according to an embodiment of the present disclosure. In particular, FIG. 8 schematically illustrates the overall shape of the terminal portion 60 described with reference to FIGS. 4 to 7. In FIG. 8, a upper cap 61 is shown as an example of the terminal portion 60.

The terminal portion 60 includes a metal layer M and a plating layer P surrounding at least a portion of the metal layer M. The terminal portion 60 also includes a pattern 61P formed on at least a portion thereof. In this case, the pattern 61P is formed on the metal layer M and the plating layer P. In the manufacturing process, the pattern 61P may first be formed in the metal layer M. Thereafter, the plating layer P may be applied on the metal layer M on which the pattern 61P is formed. Thus, the plating layer P is formed to have an uneven structure corresponding to the pattern 61P formed on the metal layer M. And the pattern 61P may be formed on both the metal layer M and the plating layer P.

In the example depicted in FIG. 8, the pattern 61P includes, for example, an engraved pattern forming grooves. Through such a structure, the pattern 61P is formed on at least a portion of a surface of the terminal portion 60. The terminal portion 60 may be in contact with the connection member 300 through an area (for example, a ridge portion 611) on which the pattern 61P is formed. Accordingly, the terminal portion 60 is provided with improved welding strength to the connection member 300.

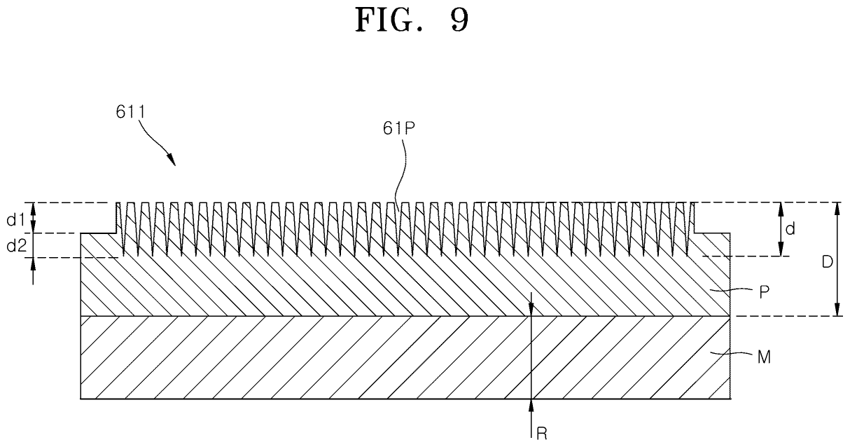

FIG. 9 is a view of a roughness formed on a terminal portion according to an embodiment of the present disclosure.

In FIG. 9, a portion of a ridge portion 611 in a upper cap 61 is enlarged and shown as an example of the terminal portion 60. In this case, the ridge portion 611 refers to an area that is connected to the connection member 300. Unlike that shown in FIG. 9, when the entire area of the terminal portion 60 is connected to the connection member 300, the description of the ridge portion 611 to be provided below may be applied to the entire area or partial area of the terminal portion 60.

The terminal portion 60 includes the metal layer M. For example, the upper cap 61 includes the metal layer M. The metal layer M includes any material having conductivity. For example, the metal layer M includes a metal. A description of the metal layer M is the same as or similar to the description provided with reference to FIGS. 4 to 8.

The plating layer P is formed by being applied on at least a portion of the metal layer M. For example, the plating layer P may be applied on the metal layer M by covering the entire surface of the metal layer M. Alternatively, the plating layer P may be applied on the metal layer M by covering only a portion of the surface of the metal layer M. The plating layer P may prevent oxidation of the metal layer M. Alternatively, the plating layer P may protect the metal layer M and/or improve the strength of the metal layer M.

The plating layer P include a metal such as nickel (Ni), copper (Cu), tungsten (W), or an alloy thereof. However, materials included in the plating layer P is not limited thereto, and the plating layer P may include any material capable of physically and/or chemically protecting the metal layer M.

The plating layer P may be formed on the metal layer M, and the pattern 61P may be formed on the plating layer P. That is, the pattern 61P may be formed only on the plating layer P rather than the metal layer M. To this end, the plating layer P should be formed to have a thickness that allows the pattern 61P to be formed.

The pattern 61P may have a roughness Ra formed on the plating layer P. For example, the pattern 61P may be form a roughness Ra by etching being performed on the plating layer P. For example, the roughness Ra may be formed through laser etching, chemical etching, or the like. Alternatively, for example, the roughness Ra may be formed through polishing using sandpaper. In still other embodiments, the roughness Ra may be formed through various methods capable of forming roughness on a surface of the plating layer P, such as sandblasting, carbon high-temperature heat coating methods, and the like.

The pattern 61P having the roughness Ra or the like may be formed based on a thickness D of the plating layer P. In FIG. 9, D denotes the thickness of the plating layer P.

For example, the roughness Ra is formed to a depth that is 15% or less of the thickness D of the plating layer P. In other examples, the roughness Ra is formed to a depth that is 14% or less of the thickness D of the plating layer P, the roughness Ra is formed to a depth that is 13% or less of the thickness D of the plating layer P, the roughness Ra is formed to a depth that is 12% or less of the thickness D of the plating layer P, or the roughness Ra is formed to a depth that is 11% or less of the thickness D of the plating layer P. When the roughness Ra is formed to a depth exceeding 15% of the thickness D of the plating layer P, the plating layer P may be damaged during a process of forming the roughness Ra. Therefore, it is preferable that the roughness Ra be formed to a depth that is 15% or less of the thickness D of the plating layer P.

In specific examples, when the thickness D of the plating layer P is 10 μm, the roughness Ra may be formed to a depth of 1 μm, or the roughness Ra is formed to a depth of 1.0 μm to 1.30 μm.

In FIG. 9, d denotes an etching height of the pattern 61P having the roughness Ra. In this case, the etching height d is an average etching height of the pattern 61P. In addition, d1 denotes a relief height in the pattern 61P having the roughness Ra. In this case, the relief height d1 is an average relief height of the pattern 61P. Further, d2 denotes an intaglio height in the pattern 61P having the roughness Ra. In this case, the intaglio height d2 is an average intaglio height of the pattern 61P.

As shown in FIG. 9, the sum of the relief height d1 and the intaglio height d2 is the etching height d. The relief height d1 and the intaglio height d2 may have the same value or similar values. In some examples, the relief height d1 may be formed to have a value that is 0.8 times to 1.2 times the intaglio height d2.

In FIG. 9, R denotes a thickness of the metal layer M. The plating layer P is formed to have a thickness that is 2% or less of the thickness R of the metal layer M. In other examples, the plating layer P is formed to have a thickness that is 0.7% or more of the thickness R of the metal layer M. As specific example, when the thickness R of the metal layer M is 600 μm, a thickness D of the plating layer P may be formed to be 10 μm. Thus, the plating layer P may be undamaged even when the roughness Ra is formed on at least a portion thereof.

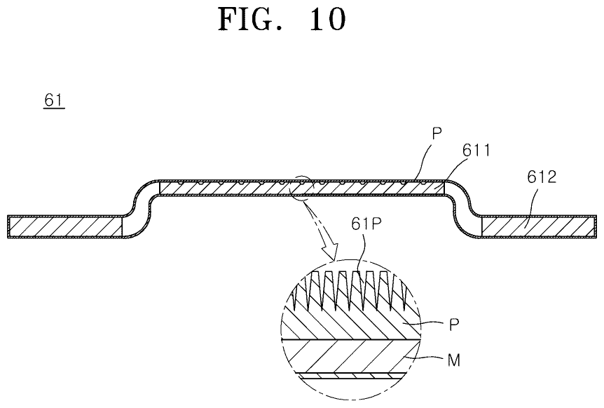

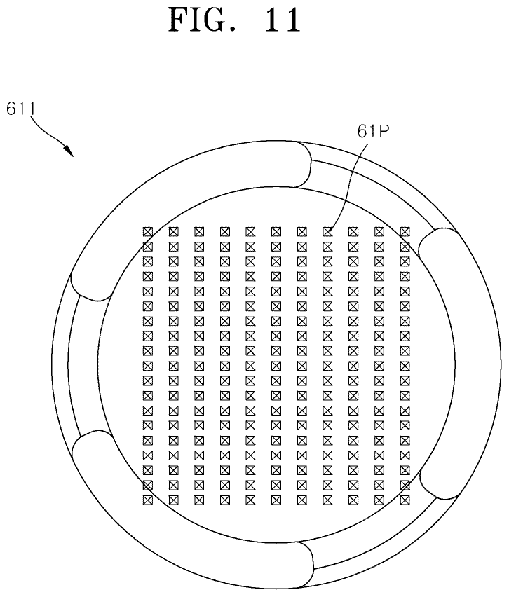

FIG. 10 is a schematic view of a terminal portion according to one embodiment of the present disclosure. FIG. 10 schematically illustrates the overall shape of a terminal portion 60 described with reference to FIG. 9. In FIG. 10, a upper cap 61 is shown as an example of the terminal portion 60.

As shown in FIG. 10, the terminal portion 60 includes a metal layer M and a plating layer P surrounding at least a portion of the metal layer M. The terminal portion 60 includes a pattern 61P formed on at least a portion thereof. In this example, the pattern 61P is formed on the plating layer P. For example, the pattern 61P is formed in the plating layer P with which the metal layer M is plated. In this case, the pattern 61P includes a roughness Ra formed, for example, through etching.

Through such a structure, the pattern 61P is formed on at least a portion of a surface of the terminal portion 60. The terminal portion 60 may be in contact with the connection member 300 through an area (for example, a ridge portion 611) on which the pattern 61P is formed. Accordingly, the terminal portion 60 can improve the welding strength with the connection member 300.

FIGS. 11-13 are schematic views in which patterns are formed on terminal portions according to embodiments of the present disclosure.

In FIGS. 11 to 13, the upper cap 61 is shown as an example of the terminal portion 60. However, as described with reference to FIGS. 4 to 6, the description of the terminal portion 60 according to embodiments of the present disclosure is limited to the upper cap 61, and descriptions to be provided below may be modified to have the same or similar form and applied to the terminal portion 60 with various shapes.

The upper cap 61 includes an edge portion 612 in contact with the lower cap 64, and a ridge portion 611 that protrudes upward from the edge portion 612 to form an upper portion of the upper cap 61. The pattern 61P is formed on at least a portion of the ridge portion 611.

As shown in FIG. 11, the pattern 61P may be formed in part an area of the ridge portion 611. The pattern 61P may be disposed to form a square shape or rectangular shape. In this way, the pattern 61P may be formed only in a section for welding. Thus, the pattern 61P may improve the welding strength with the connection member 300 while maintaining the strength of the terminal portion 60.

As shown in FIG. 12, in another embodiment the pattern 61P may be formed throughout the entire area of the ridge portion 611. In this way, the pattern 61P may be easily formed on the terminal portion 60.

For example, the ridge portion 611 includes a flat portion forming a flat surface, and a bent portion connected to the flat portion and bent toward the edge portion 612, and the pattern 61P is formed on at least a portion of the flat portion. In this case, the bent portion includes an area extending outward from an outer edge of the flat portion.

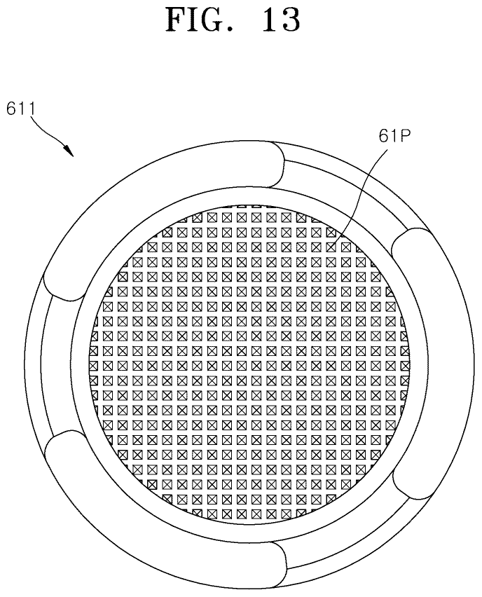

As shown in FIG. 13, the pattern 61P may be formed in part of the area of the ridge portion 611. For example, the pattern 61P may be formed on at least a part of the flat portion F. Thus, the pattern 61P can improve the welding strength with the connection member 300. In this embodiment, the pattern 61P is not formed on the bent portion B. In this way, the pattern 61P may be disposed only in an area in which an uneven structure may be definitely formed.

The pattern 61P may be formed on the terminal portion 60 to have various arrangements. For example, the pattern 61P may be based on a size of an area in contact with the connection member 300, a shape of the area in contact with the connection member 300, a shape of the terminal portion 60, and the like. As such, the arrangement and configuration of the pattern 61P formed on the terminal portion 60 is not limited to embodiments depicted in FIGS. 11 to 13.

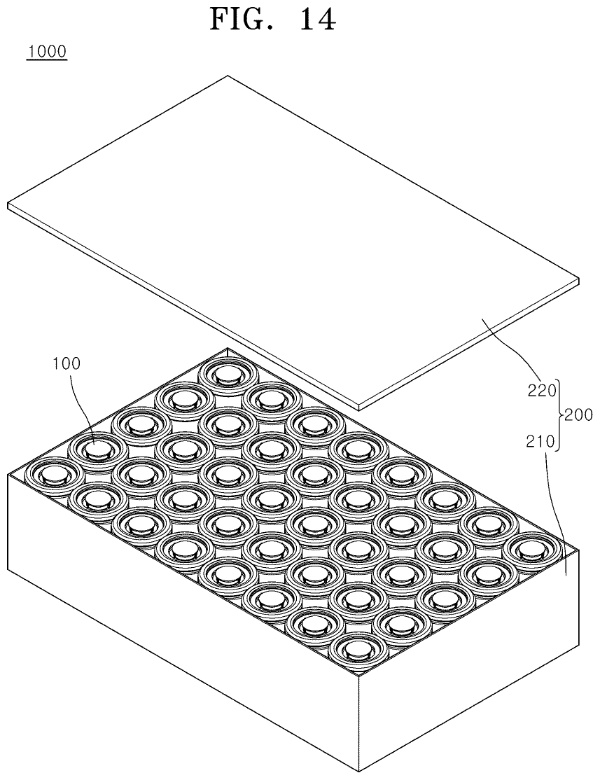

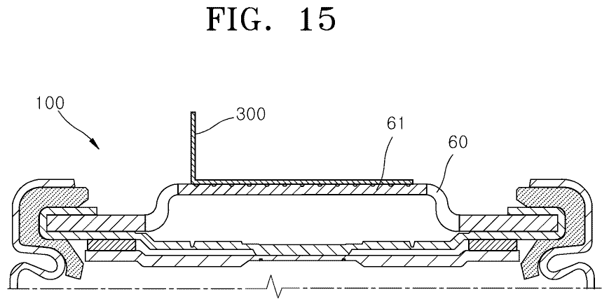

FIG. 14 is a schematic perspective view of a battery module according to an embodiment of the present disclosure. FIG. 15 is a schematic cross-sectional view of an example in which a terminal portion is connected to a connection member according to an embodiment of the present disclosure.

A battery module 1000 according to an embodiment of the present disclosure includes a plurality of secondary batteries 100, a housing 200 for accommodating the plurality of secondary batteries 100, and a connection member 300 electrically connected to at least a portion of each of the plurality of secondary batteries 100. As described above, each of the secondary batteries 100 may include a case 50 for accommodating an electrode assembly 40, and a terminal portion 60 coupled to the case 50 and electrically connected to the connection member 300. The terminal portion 60 may include a metal layer M, and a plating layer P covering at least a portion of the metal layer M, and at least a portion of an upper portion thereof includes a pattern 61P that is surface-treated.

The connection member 300 is electrically connected to each of the secondary batteries 100. The connection member 300 includes a protection circuit, a safety element, a battery management system (BMS), a busbar, a lead tab, a tab, and the like. However, examples of the connection member 300 are not limited, and the connection member 300 may include any component connected to the secondary battery 100 through the terminal portion 60.

The connection member 300 is connected to one of the secondary batteries 100. For example, the connection member 300 may be bonded and connected to the terminal portion 60 of one of the secondary batteries. For example, the connection member 300 may be welded and electrically connected to the terminal portion 60. More specifically, the connection member 300 is welded and connected to an upper portion of the terminal portion 60 on which the pattern 61P is formed.

The pattern 61P may be formed on at least a portion of an upper portion of the metal layer M, and the plating layer P covers the metal layer M on which the pattern 61P is formed. In examples, the pattern 61P may include an engraved pattern formed to a depth of 30% or less of a thickness of the metal layer M.

Alternatively, for example, the plating layer P is formed on the metal layer M, and the pattern 61P includes roughness Ra formed on the plating layer P. In this case, for example, the roughness Ra is formed to be less than 15% of a thickness of the plating layer P.

With such a structure and configuration, the terminal portion 60 may be in contact over a wide area with the connection member 300. Accordingly, the secondary batteries 100 may have high welding strength to be bonded to the connection members 300. In addition, the battery module 1000 is made safer.

Table 1 below shows the welding strength between a terminal portion and a connection member according to a comparative example and the welding strength between a terminal portion 60 and a connection member 300 according to an embodiment of the present disclosure. The numerical values shown in Table 1 below are merely exemplary, and the present disclosure is not limited to configurations and/or the numerical values evidenced by and shown in Table 1.

TABLE 1

| | Comparative | | | | |
|---|---|---|---|---|---|
| | Example | Example 1 | Example 2 | Example 3 | Example 4 |
| Welding | 9.1 | 13.1 | 15.2 | 11.5 | 14.5 |
| strength | 9.4 | 14.1 | 16.2 | 10.9 | 13.4 |
| (kgf/mm²) | 9.5 | 12.9 | 14.5 | 11.2 | 14.7 |
| | 8.7 | 13.0 | 13.9 | 14.2 | 15.2 |
| | 9.0 | 12.7 | 14.6 | 10.8 | 15.4 |
| Average | 9.14 | 13.16 | 14.88 | 11.72 | 14.64 |

In the structures represented in Table 1, the terminal portions of the Comparative Example and Examples 1 to 4 included metal layers coated with plating layers. The plating layers included nickel (Ni), the metal layers included iron (Fe), and the connection members included lead tabs including Fe. A pattern was not formed in the terminal portion of the Comparative Example. The welding strength (kgf/mm²) was obtained by measuring tensile strength after performing welding between the terminal portion and the connection member according to the Comparative Example.

In Examples 1 to 4 patterns were formed on the terminal portions of Examples 1 to 4. Specifically engraved terminal portions were formed in Examples 1 and 2. The engraved pattern of Example 1 was as described above with reference to FIG. 6 and had an average depth r of 0.06 mm. The engraved pattern of Example was as described above with reference to FIG. 5 and had an average depth r of 0.1 mm. In Examples 1 and 2, an average thickness D of a upper cap was 0.6 mm.

In Examples 3 and 4 a roughness was formed on the terminal portions. In Example 3, an average etching height d was 0.002 mm, and in Example 4 an average etching height d was 0.005 mm. The welding strength (kgf/mm²) was obtained by measuring tensile strength after performing welding between the terminal portions and the connection members according to Examples 1 to 4. In Examples 1 to 4, the average thickness D of a plating layer P was 10 μm.

As can be seen from the results shown Table 1, terminal portions according to Examples of the present disclosure have higher welding strength in relation to connection members compared to the terminal portions of the Comparative Example. For example, the terminal portion according to embodiments of the present disclosure may have a welding strength of 13 kgf/mm² or more in relation to the connection member. As another example, the terminal portion 60 according to embodiments of the present disclosure may have a welding strength of 13.16 kgf/mm² or more in relation to the connection member 300.

According to embodiments of the present disclosure, the welding strength between a terminal portion of a secondary battery and a connection member can be improved.

According to embodiments of the present disclosure, a separate foreign material removal process is not required for welding a terminal portion of a secondary battery and a connection member.

According to embodiments of the present disclosure, the dispersion of tensile strength after performing welding between a terminal portion of a secondary battery and a connection member can be reduced.

However, the effects that may be achieved through the present disclosure are not limited to the above-described effects, and other technical effects that are not described herein will be clearly understood by those skilled in the art based on the descriptions herein.

Although the present disclosure has been described by way of limited examples, the present disclosure is not limited to the specific examples. Rather, various modifications and variations within the scope of the technical spirit of the present disclosure are possible.

What is claimed is:

1. A secondary battery comprising:
a case;
an electrode assembly accommodated in the case; and
a terminal portion coupled to the case,
wherein the terminal portion includes a metal layer and a plating layer covering at least a portion of the metal layer, and
wherein at least a portion of an upper portion of the terminal portion includes a surface treatment forming a pattern.

2. The secondary battery of claim 1, wherein the pattern is formed on at least a portion of an upper portion of the metal layer, and
wherein the plating layer covers the metal layer on which the pattern is formed.

3. The secondary battery of claim 2, wherein the pattern includes an engraved pattern formed to a depth that is 30% or less of a thickness of the metal layer.

4. The secondary battery of claim 2, wherein the pattern includes a plurality of engraved patterns spaced apart from each other by distances that are 15 times or less a depth of the pattern.

5. The secondary battery of claim 2, wherein the pattern includes a plurality of engraved patterns having widths that narrow from upper portions of the engraved patterns to lower portions of the engraved patterns.

6. The secondary battery of claim 2, wherein the pattern includes a plurality of engraved patterns having widths that narrow from upper portions of the engraved patterns to lower portions of the engraved patters, and the lower portions of the engraved patterns are flat surfaces.

7. The secondary battery of claim 1, wherein the plating layer is formed on the metal layer, and
wherein the pattern is formed in the plating layer.

8. The secondary battery of claim 7, wherein the pattern forms a roughness in the plating layer.

9. The secondary battery of claim 8, wherein the roughness is formed to a depth of 15% or less of a thickness of the plating layer.

10. The secondary battery of claim 8, wherein the roughness is formed to a depth of 1.0 μm or more.

11. The secondary battery of claim 7, wherein the plating layer has a thickness of 2% or less of a thickness of the metal layer.

12. The secondary battery of claim 1, wherein the terminal portion includes:
a upper cap;
a lower cap positioned below the upper cap;
a vent positioned between the upper cap and the lower cap, with the vent including a notch; and
an insulator located between the lower cap and the vent and configured to insulate the lower cap from the vent.

13. The secondary battery of claim 12, wherein the upper cap includes an edge portion in contact with the lower cap and a ridge portion that protrudes upward from the edge portion to form an upper portion of the upper cap, and
wherein the pattern is formed in at least a portion of the ridge portion.

14. The secondary battery of claim 13, wherein the ridge portion includes a flat portion forming a flat surface and a bent portion connected to the flat portion and bent toward the edge portion, and
wherein the pattern is formed in at least a portion of the flat portion.

15. A battery module comprising:
a plurality of secondary batteries;
a housing configured to accommodate the plurality of secondary batteries; and
a connection member electrically connected to at least a portion of each of the secondary batteries,
wherein each of the secondary batteries includes:
a case,
an electrode assembly accommodated in the case, and
a terminal portion coupled to the case and electrically connected to the connection member,
wherein the terminal portion includes a metal layer and a plating layer covering at least a portion of the metal layer, and
wherein at least a portion of an upper portion of the terminal portion includes a surface treatment forming a pattern.

16. The battery module of claim 15, wherein the connection member is welded and connected to an upper portion of the terminal portion on which the pattern is formed.

17. The battery module of claim 15, wherein the pattern is formed on at least a portion of an upper portion of the metal layer, and
wherein the plating layer covers the metal layer on which the pattern is formed.

18. The battery module of claim 17, wherein the pattern includes an engraved pattern formed to a depth of 30% or less of a thickness of the metal layer.

19. The battery module of claim 15, wherein the plating layer is formed on the metal layer, and
wherein the pattern forms a roughness in the plating layer.

20. The battery module of claim 19, wherein the pattern forms a roughness that is formed to a depth that is 15% or less of a thickness of the plating layer.
